(19) United States
(12) Patent Application Publication
(10) Pub. No.: US 2024/0163007 A1
(43) Pub. Date: May 16, 2024

(54) ENHANCED CHANNEL QUALITY REPORTING

(71) Applicant: Sony Group Corporation, Tokyo (JP)

(72) Inventors: Busuki PRIYANTO, Lund (SE); Rui NUNES, Lund (SE); Shin Horng WONG, Basingstoke (GB); Anders BERGGREN, Lund (SE); Ola CEDELL, Malmö (SE); Adnan PRLJA, Malmö (SE); Jacob WAEDUEMASOR, Lund (SE)

(21) Appl. No.: 18/282,763

(22) PCT Filed: Mar. 15, 2022
(86) PCT No.: PCT/EP2022/056702

§ 371 Date: Sep. 18, 2023

(30) Foreign Application Priority Data
Mar. 31, 2021 (SE) 2150410-5

(51) Int. Cl. H04L 1/00; H04W 24/10

(52) U.S. Cl. CPC H04L 1/0009; H04L 1/0003; H04L 1/0026; H04W 24/10

(57) ABSTRACT

Techniques of performing a dynamic link adaptation protocol and specifically providing a channel quality indicator, CQI, are disclosed.

### TECHNICAL FIELD

Various examples of the disclosure are broadly concerned with a dynamic link adaptation protocol. Specifically, various examples are concerned with channel quality reporting.

### BACKGROUND

Wireless communications, specifically cellular wireless communication, is evolving. The Third Generation Partnership Projection (3GPP) 5G New Radio (NR) technology is expected to support Extended Reality (XR) applications, such as Virtual Reality (VR), Augmented Reality (AR), and Cloud gaming (CG). Data services supporting such applications typically require high data rates (e.g., video streaming), multistreams, and low packet delay. I.e., the performance requirements of the data services are challenging.

The existing 5G NR protocol is designed to support enhanced Mobile Broadband (eMBB), Ultra-Reliable Low Latency Communication (URLLC), and massive Machine Type Communications (mMTC). eMBB can deliver high data rates with best effort, i.e., data can be retransmitted several times with the cost of additional delay. URLLC can provide ultra-reliable and low-latency transmission designed for small data packet (e.g., sensors data).

### SUMMARY

There is a need to provide data services with high data rates and with reasonable reliability.

This need is met by the features of the independent claims. The features of the dependent claims define embodiments.

A method of operating a wireless communication device is provided. The wireless communication device communicates with a node of a communications network. The method includes communicating, between the node and the wireless communication device, at least one setting. The at least one setting is to be used at the wireless communication device for determining a channel quality indicator. The channel quality indicator is indicative of at least one modulation and/or coding value for said communicating of the data in accordance with the target error rate of said communicating of the data. The method also includes monitoring of reference signals that are transmitted by the node. The method further includes providing, to the node, the channel quality indicator based on said monitoring, the channel quality indicator being determined in accordance with the communicated at least one setting.

A computer program or a computer-program product or a computer-readable storage medium includes program code. The program code can be loaded and executed by at least one processor. Upon loading and executing the program code, the at least one processor performs a method of operating a wireless communication device. The wireless communication device communicates with a node of a communications network. The method includes communicating, between the node and the wireless communication device, at least one setting. The at least one setting is to be used at the wireless communication device for determining a channel quality indicator. The channel quality indicator is indicative of at least one modulation and/or coding value for said communicating of the data in accordance with the target error rate of said communicating of the data. The method also includes monitoring of reference signals that are transmitted by the node. The method further includes providing, to the node, the channel quality indicator based on said monitoring, the channel quality indicator being determined in accordance with the communicated at least one setting.

A wireless communication device for communicating data with a node of a communications network is provided. The wireless communication device includes a control circuitry. The control circuitry is configured to communicate at least one setting between the node and the wireless communication device. The at least one setting is to be used at the wireless communication device for determining a channel quality indicator. The channel quality indicator is indicative of at least one modulation and/or coding value for said communicating of the data in accordance with a target error rate of said communicating of the data. The control circuitry is further configured to monitor reference signals that are transmitted by the node. The control circuitry is further configured to provide, to the node, the channel quality indicator based on said monitoring of the reference signals. The channel quality indicator has been determined in accordance with the communicated at least one setting.

A method of operating a wireless communication device communicating data with an node of a communications network is provided. The method includes monitoring of reference signals transmitted by the node. The method also includes providing multiple channel quality indicators to the node, based on said monitoring of the reference signals. Each channel quality indicator of the multiple channel quality indicators is indicative of a respective modulation and/or coding value for said communicating of the data in accordance with a respective one of multiple target error rates.

A computer program or a computer-program product or a computer-readable storage medium includes program code. The program code can be loaded and executed by at least one processor. Upon loading and executing the program code, the at least one processor performs a method of operating a wireless communication device. The method includes monitoring of reference signals transmitted by the node. The method also includes providing multiple channel quality indicators to the node, based on said monitoring of the reference signals. Each channel quality indicator of the multiple channel quality indicators is indicative of a respective modulation and/or coding value for said communicating of the data in accordance with a respective one of multiple target error rates.

A wireless communication device for communicating data with a node of a communications network is provided. The wireless communication device includes a control circuitry. The control circuitry is configured to monitor reference signals that are transmitted by the node. The control circuitry is further configured to provide multiple channel quality indicators that are indicative of a respective modulation and/or coding value for said communicating of the data in accordance with the respective one of multiple target error rates, based on said monitoring of the reference signals.

A method of operating a node of a communications network is provided. The node communicates data with a wireless communication device. The method includes communicating at least one setting between the node and the wireless communication device. The at least one setting is to be used at the wireless communication device for determining a channel quality indicator. The channel quality indicator is indicative of at least one modulation and/or coding value for said communicating of the data in accordance with a target error rate of said communicating of the data. The method further includes transmitting reference signals. The method further includes obtaining, from the wireless communication device, the channel quality indicator that is determined in accordance with the communicated at least one setting.

A computer program or a computer-program product or a computer-readable storage medium includes program code. The program code can be loaded and executed by at least one processor. Upon loading and executing the program code, the at least one processor performs a method of operating a node of a communications network. The node communicates data with a wireless communication device. The method includes communicating at least one setting between the node and the wireless communication device. The at least one setting is to be used at the wireless communication device for determining a channel quality indicator. The channel quality indicator is indicative of at least one modulation and/or coding value for said communicating of the data in accordance with a target error rate of said communicating of the data. The method further includes transmitting reference signals. The method further includes obtaining, from the wireless communication device, the channel quality indicator that is determined in accordance with the communicated at least one setting.

A node of a communications network is provided. The node communicates data with a wireless communication device. The node includes a control circuitry. The control circuitry is configured to communicate at least one setting between the node and the wireless communication device. The at least one setting is to be used at the wireless communication device for determining a channel quality indicator. The channel quality indicator is indicative of at least one modulation and/or coding value for said communicating of the data in accordance with the target error rate of said communicating of the data. The control circuitry is further configured to transmit reference signals. The control circuitry is further configured to obtain, from the wireless communication device, the channel quality indicator that is determined in accordance with the communicated at least one setting.

A method of operating a node of a communications network is provided. The node is communicating data with a wireless communication device. The method includes transmitting reference signals and obtaining multiple channel quality indicators from the wireless communication device. Each channel quality indicator of the multiple channel quality indicators is indicative of a respective modulation and/or coding value of said communicating of the data, in accordance with a respective target error rate of multiple target error rates.

A computer program or a computer-program product or a computer-readable storage medium includes program code. The program code can be loaded and executed by at least one processor. Upon loading and executing the program code, the at least one processor performs a method of operating a node of a communications network. The node communicates data with a wireless communication device. The method includes transmitting reference signals and obtaining multiple channel quality indicators from the wireless communication device. Each channel quality indicator of the multiple channel quality indicators is indicative of a respective modulation and/or coding value of said communicating of the data, in accordance with a respective target error rate of multiple target error rates.

A node of a communications network is provided. The notice for communication of data with a wireless communication device. The node includes a control circuitry. The control circuitry is configured to transmit reference signals and to obtain multiple channel quality indicators from the wireless communication device. Each channel quality indicator of the multiple channel quality indicators is indicative of a respective modulation and/or coding value of said communicating of the data, in accordance with a respective target error rate of multiple target error rates.

It is to be understood that the features mentioned above and those yet to be explained below may be used not only in the respective combinations indicated, but also in other combinations or in isolation without departing from the scope of the invention.

### BRIEF DESCRIPTION OF THE DRAWINGS

FIG. 1 schematically illustrates a cellular NW and a UE connected to the cellular NW according to various examples.

FIG. 2 is a signaling diagram illustrating a dynamic link adaptation protocol according to various examples.

FIG. 3 is a signaling diagram illustrating a retransmission protocol according to various examples.

FIG. 4 schematically illustrates a correlation between delay and retransmissions of the retransmission protocol according to various examples.

FIG. 5 schematically illustrates a UE according to various examples.

FIG. 6 schematically illustrates a base station according to various examples.

FIG. 7 is a flowchart of a method according to various examples.

FIG. 8 schematically illustrates a parametrized ruleset for a dynamic link adaptation protocol according to various examples.

FIG. 9 schematically illustrates an enhanced channel quality report message according to various examples.

FIG. 10 schematically illustrates an enhanced channel quality report message according to various examples.

FIG. 11 schematically illustrates a parametrized ruleset for a dynamic link adaptation protocol according to various examples.

FIG. 12 is a flowchart of a method according to various examples.

FIG. 13 is a signaling diagram of communication between a UE and a base station according to various examples.

FIG. 14 is a flowchart of a method according to various examples.

FIG. 15 is a flowchart of a method according to various examples.

FIG. 16 is a signaling diagram of communication between a UE and a base station according to various examples.

FIG. 17 is a flowchart of a method according to various examples.

### DETAILED DESCRIPTION OF EMBODIMENTS

Some examples of the present disclosure generally provide for a plurality of circuits or other electrical devices. All references to the circuits and other electrical devices and the functionality provided by each are not intended to be limited to encompassing only what is illustrated and described herein. While particular labels may be assigned to the various circuits or other electrical devices disclosed, such labels are not intended to limit the scope of operation for the circuits and the other electrical devices. Such circuits and other electrical devices may be combined with each other and/or separated in any manner based on the particular type of electrical implementation that is desired. It is recognized that any circuit or other electrical device disclosed herein may include any number of microcontrollers, a graphics processor unit (GPU), integrated circuits, memory devices (e.g., FLASH, random access memory (RAM), read only memory (ROM), electrically programmable read only memory (EPROM), electrically erasable programmable read only memory (EEPROM), or other suitable variants thereof), and software which co-act with one another to perform operation(s) disclosed herein. In addition, any one or more of the electrical devices may be configured to execute a program code that is embodied in a non-transitory computer readable medium programmed to perform any number of the functions as disclosed.

In the following, examples of the disclosure will be described in detail with reference to the accompanying drawings. It is to be understood that the following description of examples is not to be taken in a limiting sense. The scope of the disclosure is not intended to be limited by the examples described hereinafter or by the drawings, which are taken to be illustrative only.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

Techniques are described that facilitate wireless communication between communication nodes (CNs; hereinafter, simply node). In some examples, the wireless communication system can be implemented by a wireless communication network, e.g., a radio-access network (RAN) of a 3GPP-specified cellular network (NW). In such case, the nodes can be implemented by an access node such as a base station (BS) of the RAN and by wireless communication devices (also referred to as user equipment, UE).

A communication between a BS and a UE can include communicating data from the BS to the UE (downlink, DL) and from the UE to the BS (uplink, UL). Also, sidelink (SL) communication between two UEs, or generally two peers, would be possible.

Hereinafter, various aspects will be described with respect to DL communication. Similar techniques may be readily applied for UL communication or SL communication.

Various techniques are based on the finding that some applications, such as high quality and real time video streaming applications, require data services with high data rates and low packet delay. TAB. 1 summarizes example requirements for data services that support certain demanding applications.

TABLE 1
Example performance requirements for data services
supporting VR/AR and CG applications, respectively.

| Appli- | Bitrate for downlink | Air interface packet delay budget |
|---|---|---|
| cation | video streaming | (PDB) for video streaming |
| VR/AR | 30, 45 Mbps @ 60 fps | 10 ms (mandatory), 5, 20 ms |
| | (mandatory), 60 Mbps @ | (optional) |
| | 60 fps (optional) | |
| CG | 8, 30 Mbps @ 60 fps | 15 ms (mandatory), 10, 30 ms |
| | (mandatory), 45 Mbps @ | (optional) |
| | 60 fps (optional) | |

Hereinafter, techniques will be described which help to meet such challenging performance requirements as illustrated in TAB. 1.

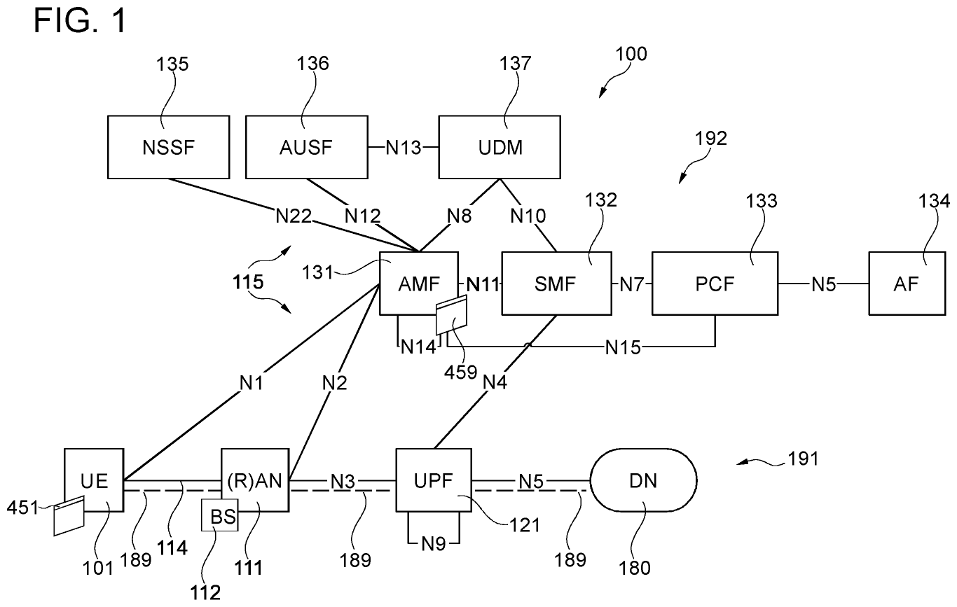

FIG. 1 schematically illustrates a cellular NW 100. The example of FIG. 1 illustrates the cellular NW 100 according to the 3GPP 5G architecture. Details of the 3GPP 5G architecture are described in 3GPP TS 23.501, v16.7.0 (2020 December). While FIG. 1 and further parts of the following description illustrate techniques in the 3GPP 5G framework of a cellular NW, similar techniques may be readily applied to other communication protocols. Examples include 3GPP LTE 4G—e.g., in the MTC or NB-IoT framework—and even non-cellular wireless systems, e.g., an IEEE Wi-Fi technology.

In the scenario of FIG. 1, a UE 101 is connectable to the cellular NW 100. For example, the UE 101 may be one of the following: a cellular phone; a smart phone; an IoT device; a MTC device; a sensor; an actuator; etc. The UE 101 has a respective identity 451, e.g., a subscriber identity.

The UE 101 is connectable to a core NW (CN) 115 of the cellular NW 100 via a RAN 111, typically formed by one or more BSs 112 (only a single BS 112 is illustrated in FIG. 1 for sake of simplicity). A radio link 114 is established between the RAN 111—specifically between one or more of the BSs 112 of the RAN 111—and the UE 101. To perform channel sounding and/or enable the UE 101 to maintain synchronization, it is possible that the BS 112 transmits reference signals (RSs). A dynamic link adaptation protocol may operate based on the RSs.

The radio link 114 implements a time-frequency resource grid. Typically, OFDM is used: here, a carrier includes multiple subcarriers. The subcarriers (in frequency domain) and the symbols (in time domain) then define time-frequency resource elements of the time-frequency resource grid. Thereby, a protocol time base is defined, e.g., by the duration of frames and subframes including multiple symbols and the start and stop positions of the frames and subframes. Different time-frequency resource elements can be allocated to different logical channels of the radio link 114. Examples include: Physical DL Shared Channel (PDSCH); Physical DL Control Channel (PDCCH); Physical Uplink Shared Channel (PUSCH); Physical Uplink Control Channel (PUCCH); channels for random access; etc. For instance, time-frequency resources on the PDSCH and PUSCH can be scheduled by using a Downlink Control Information (DCI) communicated on the PDCCH.

In some scenarios, the radio link 114 is implemented on one or more bandwidth parts (BWPs). A BWP is generally defined by a frequency range that is a subset of the entire bandwidth of a carrier. A BWP can be implemented by a contiguous set of time-frequency resources that are selected from a contiguous subset of the common time-frequency resources for a given numerology on a given carrier. BWPs are described in 3GPP Technical Specification (TS) 38.211, Version 16.4.0, 2021 Jan. 8. I.e., different BWPs share the same carrier. In reference implementations, only a single BWP can be active at a time (active BWP). Various techniques are available for switching between BWPs. A specific BWP can be activated by Bandwidth part indicator in DCI Format 0_1 (a UL Grant) and DCI Format 0_1 (a DL Schedule). An inactivity timer can be used. RRC signaling can be used.

The CN 115 includes a user plane (UP) 191 and a control plane (CP) 192. Application data is typically routed via the UP 191. For this, there is provided a UP function (UPF) 121. The UPF 121 may implement router functionality. Application data may pass through one or more UPFs 121. In the scenario of FIG. 1, the UPF 121 acts as a gateway towards a data NW 180, e.g., the Internet or a Local Area NW. Application data can be communicated between the UE 101 and one or more servers on the data NW 180.

The cellular NW 100 also includes a mobility-control node, here implemented by an Access and Mobility Management Function (AMF) 131 and a Session Management Function (SMF) 132.

The cellular NW 100 further includes a Policy Control Function (PCF) 133; an Application Function (AF) 134; a NW Slice Selection Function (NSSF) 134; an Authentication Server Function (AUSF) 136; and a Unified Data Management (UDM) 137. FIG. 1 also illustrates the protocol reference points N1-N22 between these nodes.

The AMF 131 provides one or more of the following functionalities: connection management sometimes also referred to as registration management; NAS termination for communication between the CN 115 and the UE 101; connection management; reachability management; mobility management; connection authentication; and connection authorization. For example, the AMF 131 controls CN-initiated paging of the UE 101, if the respective UE 101 operates in the idle mode.

A data connection 189 is established by the SMF 132 if the respective UE 101 operates in a connected mode. The data connection 189 is characterized by UE subscription information hosted by the UDM 137. To keep track of the current mode of the UE 101, the AMF 131 sets the UE 101 to CM-CONNECTED or CM-IDLE. During CM-CONNECTED, a non-access stratum (NAS) connection is maintained between the UE 101 and the AMF 131. The NAS connection implements an example of a mobility control connection. The NAS connection may be set up in response to paging of the UE 101.

The SMF 132 provides one or more of the following functionalities: session management including session establishment, modify and release, including bearers set up of UP bearers between the RAN 111 and the UPF 121; selection and control of UPFs; configuring of traffic steering; roaming functionality; termination of at least parts of NAS messages; etc. As such, the AMF 131 and the SMF 132 both implement CP mobility management needed to support a moving UE.

The data connection 189 is established between the UE 101 and the RAN 111 and on to the UP 191 of the CN 115 and towards the DN 180. For example, a connection with the Internet or another packet data NW can be established. To establish the data connection 189, i.e., to connect to the cellular NW 100, it is possible that the respective UE 101 performs an RA procedure, e.g., in response to reception of paging signals. This establishes at least a RAN-part of the data connection 189. A server of the DN 180 may host a service for which payload data is communicated via the data connection 189. The data connection 189 may include one or more bearers such as a dedicated bearer or a default bearer. The data connection 189 may be defined on the RRC layer, e.g., generally Layer 3 of the OSI model.

The data connection 189 can support one or more data services. I.e., application data of an application associated with such a data service can be communicated on the data connection 189. Example applications have been discussed in connection with TAB. 1.

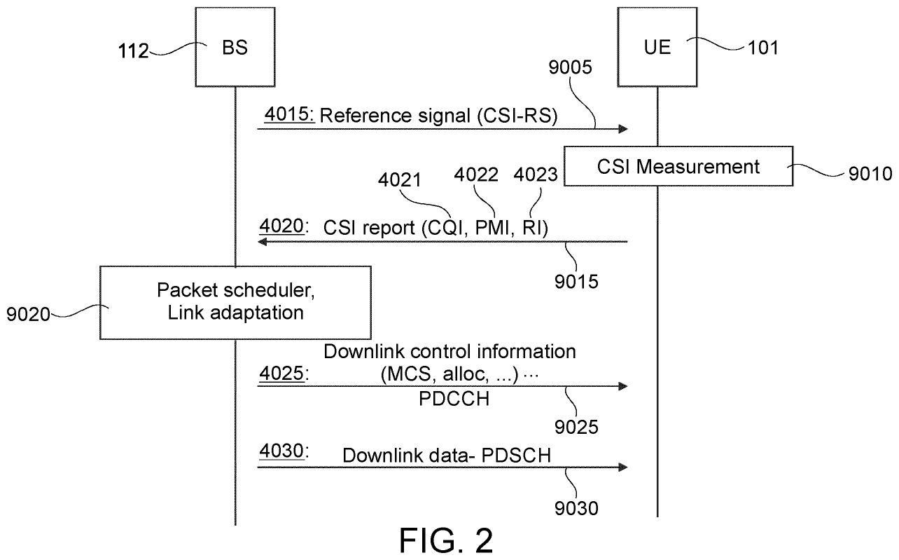

Further details with respect to such communication of application data are described in connection with FIG. 2.

FIG. 2 schematically illustrates aspects with respect to communicating application data 4030. For illustration, it is assumed that the application data includes a video frame.

A video frame—defined by the respective application—is typically divided into multiple Internet Protocol packets and further divided into multiple transport blocks (TBs) defined by a respective transport block size. Furthermore, the modulation and coding scheme (MCS) of a TB is chosen based on the radio environment and the configured error rate target (e.g., Block Error Rate (BLER)), to maximize the throughput. The MCS selection is part of a dynamic link adaptation protocol.

Generally speaking, the MCS defines the modulation that is used, e.g., Phase Shift Keying, Binary Phase Shift Keying, quadrature phase shift keying, Differential QPSK, quadrature amplitude modulation (QAM), etc.

The more complex the modulation, the higher the data rate. More complex modulations require better radio channel conditions such as less interference and a good line of sight.

The MCS also defines the coding ratio, i.e., a fraction of the total data stream that is actually being used to transmit usable data. The rest is overhead.

FIG. 2 is a signalling diagram illustrating aspects with respect to the dynamic link adaption protocol. Aspects of the dynamic link adaptation protocol illustrated in FIG. 2 are specified according to 3GPP TSs (e.g., TS 38.214 v16.20 (2020 June)).

The dynamic link adaptation protocol can be described as follows. The UE performs channel (radio link condition) measurements—also referred to as Channel State Information (CSI) measurements—that include signal to noise and interference ratio (SINR) estimation. More generally, the UE monitors, at 9010, for RSs 4015 transmitted by the BS at 9005.

Based on a receive property of the RSs, the UE can determine the condition of the radio link. Then, the UE puts together based on a certain ruleset (compiles) a channel quality report message. The channel quality report message is indicative of an MCS that could meet certain performance requirements of a data service, as estimated based on the RSs. The channel quality report message can include a value that is indicative of the channel quality. For sake of simplicity, this value is hereinafter referred to as channel quality indicator (CQI). More specifically, the CQI can be indicative of an MCS for communicating data. The CQI can suggest an MCS to be used by the BS. More specifically, the CQI can indicate the highest MCS at which a certain target error rate is not exceeded. The CQI—according to reference techniques—is determined using a reference to a target error rate, specifically the Block Error Rate (BLER) target of the measured SINR. The ruleset typically specifies the BLER target as 10%. However, for data services supporting URLLC, the BLER target is 0.001% to improve reliability. High and low BLER targets will result in higher and lower CQI index, respectively.

Apart from the CQI, the UE can also calculate and identify the best precoding matrix index (PMI) and Rank Indication (RI). The UE provides a channel quality report message 4020 (including CQI 4021, PMI 4022, and RI 4023) to the BS 112, at 9015.

The channel quality report message could be transmitted on the PUCCH or the PUSCH. It can be transmitted periodically or aperiodically, i.e., in response to a respective request from the BS 112.

The BS 112 can then—at 9020—assign the MCS for the application data 4030 of the data service based on the reported CQI 4021. Furthermore, The BS 112 can then—at 9020—assign the PMI and RI for the application data 4030 transmission of the data service based on the reported PMI 4022, RI 4023, respectively. Higher CQI 4021 corresponds to higher MCS. Hence, the throughput is higher in comparison with the data transmission with lower MCS.

The selected MCS for the TB and other parameters are conveyed by BS 112 to UE 101 in a DCI 4025 communicated on the PDCCH at 9025. The TB carrying the application data 4030 is transmitted in PDSCH at 9030.

Even when accurately setting the MCS based on the transmission of RSs—e.g., as part of the dynamic link adaptation protocol, as described above—it can happen that the transmission of the application data 4030 fails, at box 9030. To detect transmission failures, checksums can be used. For example, the TB can include a checksum. The checksum is determined based on the remaining bits of the TB, e.g., using a hashing value. Forward error correction can be used. Where a corrupted TB is detected, a retransmission of the data can be implemented.

Sometimes, the TB can be even further structured into the code block groups (CBGs) and each CBG can include a respective checksum. This helps to limit the retransmissions to fractions of the initial TB, i.e., CBG-based retransmissions.

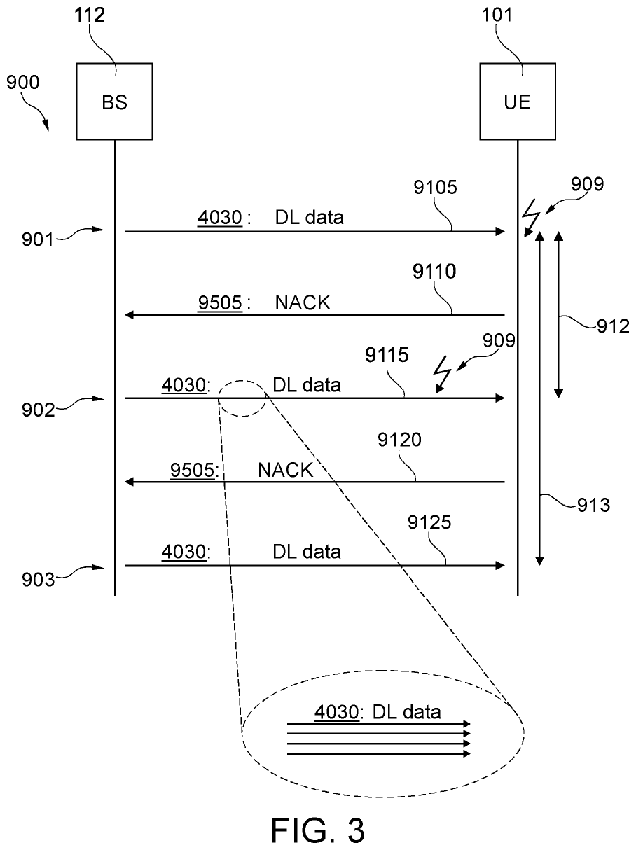

A retransmission protocol—e.g., an Automatic Repeat Request (ARQ) protocol—can be used in order to trigger one or more retransmissions in response to transmission failures. Aspects with respect to a retransmission protocol are illustrated in connection with FIG. 3.

FIG. 3 is a signaling diagram of communication between the BS 112 and the UE 101. FIG. 3 illustrates aspects with respect to a retransmission protocol 900 for protecting application data 4030 communicated from the BS 112 to the UE 101.

As a general rule—while FIG. 3 illustrates aspects with respect to the retransmission protocol 900 in the context of DL application data 4030—a retransmission protocol can also be used in order to protect UL data or SL data.

At 9105, the application data 4030 is transmitted by the BS 112. One or more TB carry the application data 4030. This corresponds to an initial transmission 901 of a given data, i.e., the first time a certain data element is transmitted. For example, 9105 could correspond to 9030 (cf. FIG. 2).

A transmission failure 909 occurs. The respective TB including the DL data 4030 does not arrive at the UE 101 or only arrives corrupted or at least partly corrupted. For instance, one or more CBGs of the TB could be corrupted.

Accordingly, the UE 101 transmits, at 9110, a negative acknowledgment (NACK) 9505 that is indicative of the transmission failure 909 that has occurred. For instance, a bitmap could indicate all corrupted CBGs.

Hence, the retransmission protocol 900 triggers a retransmission 902 at least of the corrupted parts of the DL data 4030—e.g., one or more corrupted CBGs could be retransmitted, or it would also be possible to retransmit the entire TB—at 9115.

Sometimes, a different redundancy version of the retransmitted at least parts of the application data 4030 may be transmitted; here, stronger forward error protection can be employed.

In the illustrated scenario, again a transmission failure 909 occurs; and, accordingly, the UE 101 transmits, at 9120, a NACK 9505 negatively acknowledging at least parts of the application data 4030 that has been included in the retransmission 902.

The BS 112, at 9125, implements a further retransmission 903 of at least parts of the application data 4030. As illustrated, the at least parts of the application data 4030 of the retransmission 903 arrive uncorrupted at the UE 101.

The retransmission 902 is a first order retransmission; the retransmission 903 is a second order retransmission. As a general rule, the retransmission protocol can be configured to implement a predefined count of retransmissions.

Sometimes, the initial transmission is referred to as first transmission, the first retransmission is referred to as second transmission, the second retransmission is referred to as third transmission, and so one.

FIG. 3 also illustrates aspects with respect to repetitions of the data. Specifically, the inset of FIG. 3 illustrates for the retransmission 902 that at least parts of the application data 4030 can be transmitted multiple times. This is referred to transmission repetitions. The transmission repetitions different from retransmissions in that they are proactively triggered by the BS 112, i.e., not triggered by a NACK. The transmission repetitions are sometimes also referred to as a repetition burst for coverage enhancement (CE). The count of repetitions is a transmission parameter that can be set accordingly. Using multiple repetitions increases the reliability.

As a general rule, according to various examples disclosed herein, multiple repetitions of data can be encoded according to the same redundancy version or different redundancy versions. By using different redundancy versions, different sets of coded bits representing the same set of information bits can be generated.

Using a higher count of repetitions may increase the spectrum allocation. I.e., more time-frequency resources are required to accommodate for the multiple repetitions. On the other hand, the likelihood of a transmission failure 909 is reduced.

Using repetitions is only one means to reduce the likelihood of a transmission failure 909. The values of other transmission parameters—beyond the count/number of repetitions—can be set so as to robustly protect the data. To give an example, a further transmission parameter whose value can be set accordingly is the MCS. Here, lower MCS can protect the data; on the other hand, more time-frequency resources are required.

Various examples are based on the finding that the increased spectrum allocation for higher protection of the data needs to be put in relation with the increased delay due to the retransmissions that otherwise become more likely.

As will be appreciated from FIG. 3, the retransmission 902, 903 introduce respective delays 912, 913.

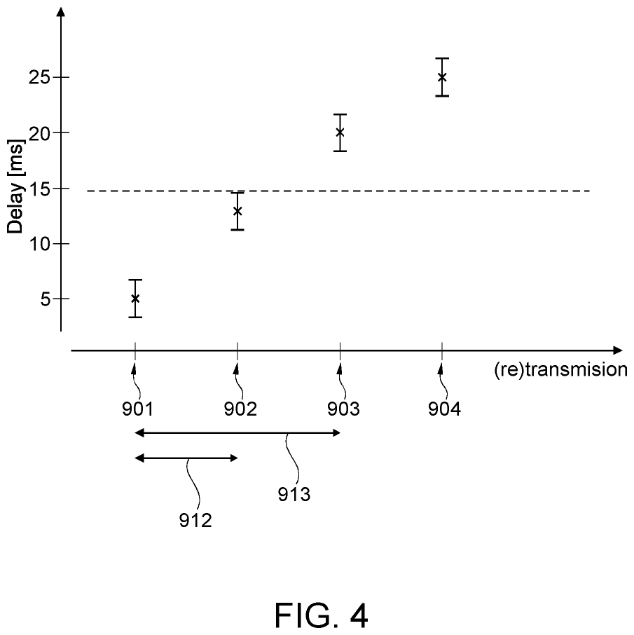

In legacy 3GPP Long Term Evolution (LTE) protocol and NR protocol, a data service uses a BLER target of 10% (High BLER target). A specific use-case in the 3GPP NR protocol, URLLC, uses a BLER target of 0.001% (low BLER target) with the main motivation to provide ultra-reliability data transmission. Higher BLER target results in the selection of higher MCS. Hence, it maximizes the instantaneous throughput. High throughput is typically needed for video streaming application (particularly with high quality 4K or 8K video resolution). However, it may increase the number of transmission failures 909 due to possible temporary bad radio link condition (e.g., UE sudden movement, blockage). The transmission failures 909 trigger retransmissions, leading to increasing packet delay. The total delay introduced by retransmission are contributed by the airtime of packet retransmission, TX buffering delay, RX packet re-ordering delay (RLC packets within a retransmitted TBs will likely be delivered to PDCP out of order; reordering at PDCP will cause additional delay on adjacent packets). The impact of packet delay due to retransmission is shown in FIG. 4.

FIG. 4 schematically illustrates an empirical dependency of the overall delay of application data of a data service due for the initial transmission 901 and subsequent retransmissions 902-904 of a retransmission protocol. As illustrated in FIG. 4, the delay increases for a larger count of retransmissions.

Various techniques are based on the finding that high packet delay should be avoided for video streaming application because it may disrupt the service or reduce the user experience quality. Recently, 3GPP has approved a study item on XR evaluations, see 3GPP RP-201145. XR includes these applications: Virtual reality (VR), Augmented Reality (AR) and Cloud gaming (CG). These are applications which require high data rate streaming with low packet delay.

Hereinafter, techniques are described which enable both high data rates, as well as low packet delay.

According to various examples, it is possible to reduce the delay in delivery of application data, by improving the reliability of retransmissions of the application data. Various techniques are based on the finding that delay in the delivery of data is typically due to the retransmissions. For example, according to the 3GPP NR protocol, a total count of four retransmissions is supported in order to improve the reliability in the delivery of the data at the cost of a long delay. It has been found that for typical configurations of the data service, a single retransmission is sufficient to meet the delay budget associated with the requirements of various data services, such as virtual reality. The respective threshold delay is illustrated by the dashed line in FIG. 4.

According to the techniques disclosed herein, the delay of delivering data due to retransmissions is reduced, at least on average. This is achieved by improving the reliability of the initial transmission. This is achieved by enhancing the dynamic link adaptation protocol.

In particular, the information content included in one or more channel quality report messages can be increased, if compared to reference implementations. Thereby, the BS can allocate a higher data rate at a better reliability. For instance, the reliability can be between reliability is of eMBB and URRLC data services.

According to the disclosure, various options are available for achieving such increased reliability. Some options are summarized below in TAB. 2.

TABLE 2
Multiple options for enhancing the channel quality reporting of a dynamic link
adaptation protocol. According to the techniques described herein, it is possible
to combine such multiple options with each other, to form further implementations.
Further details with respect to both options will be discussed below.

| | Brief description | Example details |
|---|---|---|
| I | Adapted channel | According to various examples, it is possible to |
| | quality report | communicate at least one setting for determining |
| | message | the CQI included in a channel quality report |
| | | message between the UE and the BS. |
| | | As a general rule, the at least one setting could |
| | | pertain to additional information used to interpret |
| | | the CQI. The at least one setting could pertain to a |
| | | ruleset for determining the CQI. The at least one |
| | | setting could pertain to a ruleset specifying how to |
| | | provide the additional information, e.g., piggybacked |
| | | to the channel quality report message or separately. |
| | | As a general rule, the at least one setting could be |
| | | included in the channel quality report message. The |
| | | at least one setting could also be communicated |
| | | separately from the channel quality report message. |
| | | Parts of the at least one setting could be included |
| | | in the channel quality report message, other parts |
| | | may be communicated separately. |
| | | According to various examples, such communication |
| | | of the at least one setting can be from the BS to the |
| | | UE, and/or vice versa. It is possible that the BS |
| | | and/or the UE determines the desired at least one |
| | | setting; the respective other node can be informed |
| | | accordingly. |
| | | The at least one setting may be dynamically adjusted, |
| | | e.g., during an ongoing communication of data of a |
| | | data service, e.g., while a respective data connection |
| | | is established. The at least one setting could be |
| | | adjusted based on changing conditions on the radio |
| | | link 114. According to various examples, it is possible |
| | | that the selection of the appropriate at least one |
| | | setting for compiling the channel quality report message |
| | | facilitates an arbitrary selection of the target error |
| | | rate associated with the respective CQI. Specifically, |
| | | while according to various reference implementations, |
| | | only a single BLER target is available, according to |
| | | the techniques described herein the adapted channel |
| | | quality report can facilitate selecting more or |
| | | arbitrarily defined BLER targets. The arbitrary defined |
| | | BLER target can be between 10% and 0.001%. |
| | | By receiving such adapted channel quality report, the |
| | | BS is expected to select the suitable MCS that |
| | | provides high throughput/data rate at no/small packet |
| | | delay. The selected modulation may be smaller than a |
| | | legacy modulation coding scheme at a BLER target of |
| | | 10%, i.e., the legacy eMBB BLER target for 3GPP NR. |
| II | Rich channel | According to various examples, it is possible to |
| | quality reporting | provide multiple CQIs for multiple target error rates, |
| | | e.g., in a shared channel quality report message or |
| | | in multiple channel quality reports messages that may |
| | | or may not be provided at different reporting rates. |
| | | For instance, according to reference implementations, |
| | | it is only possible to provide a channel quality report |
| | | message that includes the CQI determined for a single |
| | | BLER, at a time. According to examples described |
| | | herein, rich channel quality reporting can be enabled |
| | | and multiple CQIs can be provided within the |
| | | predetermined time duration - e.g., determined based |
| | | on the same reference signals, but for different target |
| | | error rates. For instance multiples channel quality |
| | | report messages could be provided within a predefined |
| | | count of subframes, e.g., 5 or 10 subframes. |
| | | As a general rule, according to the various examples |
| | | disclosed herein, it would be possible that the multiple |
| | | target error rates are determined or are selected by |
| | | the BS, or by the UE. Accordingly, it would be |
| | | possible that the BS informs the UE about the multiple |
| | | target error rates, or vice versa. |
| | | By using multiple CQIs for multiple target error rates, |
| | | the BS can select the appropriate MCS across various |
| | | options, e.g., meeting different or time-varying |
| | | performance requirements of an application associate |
| | | with the data service that provides the data. |

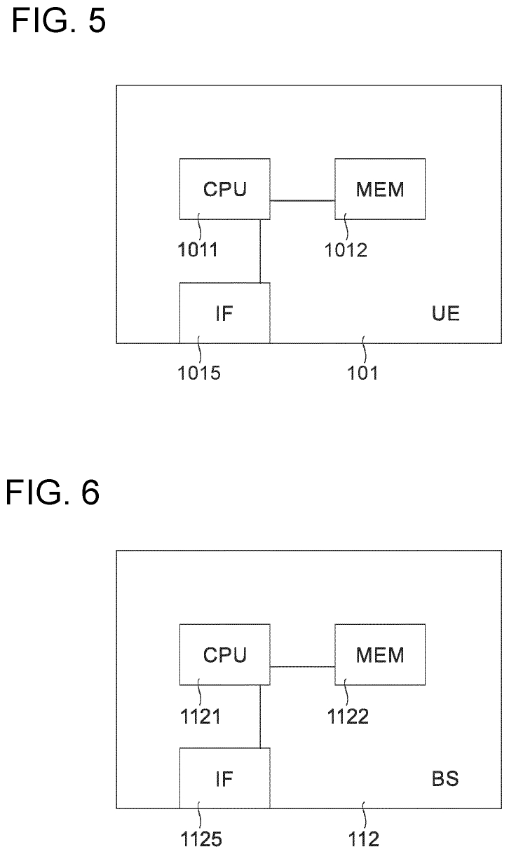

FIG. 5 schematically illustrates aspects with respect to the UE 101. The UE 101 includes a processor 1011 that is coupled with a memory 1012. The processor and the memory implement a control circuitry. The processor 1011 can load program code from the memory 1012. The processor 1011 can execute the program code. Upon executing the program code, the processor 1011 performs techniques as described herein, e.g.: participating in a dynamic link adaptation protocol, e.g., by communicating with a BS such as the BS 112 via an interface 1015 of the UE 101; attempting to receive (monitoring of) reference signals; providing a channel quality report message or multiple channel quality report message messages to the BS; providing a capability to participate in enhanced channel quality reporting, e.g., according to one of the options of TAB. 2; monitoring of one or more trigger events that trigger enhanced channel quality reporting, e.g., according to one of the options of TAB. 2; etc.

FIG. 6 schematically illustrates aspects with respect to the BS 112. The BS 112 includes a processor 1121 that is coupled with a memory 1122. The processor and the memory implement a control circuitry. The processor 1121 can load program code from the memory 1122. The processor 1121 can execute the program code. Upon executing the program code, the processor 1121 performs techniques as described herein, e.g.: participating in a dynamic link adaptation protocol, e.g., by transmitting and/or receiving (communicating) signals to or from a UE such as the UE 101; transmitting reference signals; obtaining a channel quality report message or multiple channel quality report message messages from the UE; determining a MCS for communicating data of a data service based on the one or more channel quality report message messages; obtaining a capability to participate in enhanced channel quality reporting, e.g., according to one of the options of TAB. 2; monitoring of one or more trigger events that trigger enhanced channel quality reporting, e.g., according to one of the options of TAB. 2; etc.

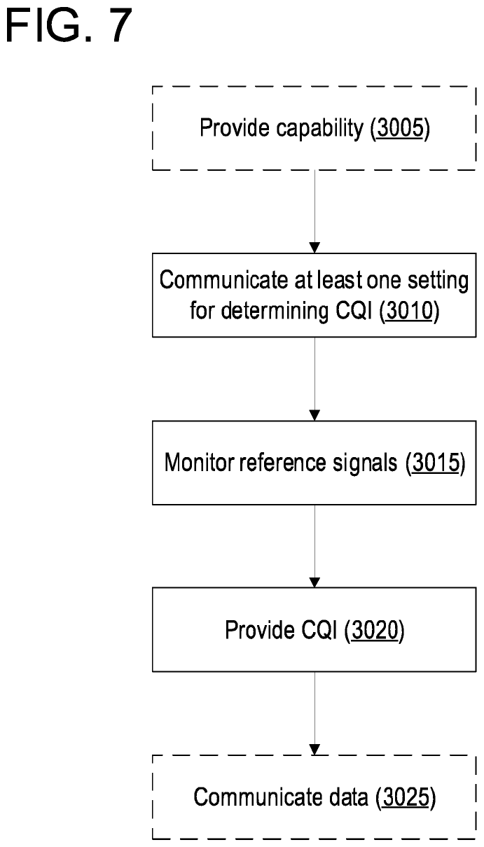

FIG. 7 is a flowchart of a method according to various examples. FIG. 7 illustrates aspects with respect to enhanced channel quality reporting according to TAB. 2: option I. For instance, the method of FIG. 7 can be executed by a UE after instructed by a BS. The UE can communicate with a communications NW. The UE could communicate with a BS of the communications NW. The UE could be the UE 101. In further detail, the method of FIG. 7 could be executed by the processor 1011 upon loading program code from the memory 1012. Optional boxes are labeled using dashed lines in FIG. 7.

At optional box 3005, the UE can indicate, to the communications NW, its capability to participate in an enhanced dynamic link adaptation protocol. The UE can indicate its capability to perform enhanced channel quality reporting. Specifically, the UE can indicate its capability to an adapted channel quality report message according to TAB. 2: example I, i.e., a channel quality report message that includes a CQI that has been determined in accordance with at least one setting that can be exchanged between the UE and the BS.

The UE could transmit, to the communications NW, a control message, e.g., a higher-layer control message, e.g., a Layer 3 control message such as a RRC control message communicated on the PUSCH. This control message can be indicative of its capability, as explained above.

Next, at box 3010, the UE can transmit and/or receive (communicate) at least one setting to be used at the UE determining the CQI. The at least one setting can also be used at the BS to interpret the CQI provided by the UE. Some details with respect to the at least one setting have been explained in connection with TAB. 2: option I.

The at least one setting can be at least partly included in a higher-layer control message, e.g., a Layer 2 or Layer 3 control message. For instance, an RRC control message may be communicated on PUSCH or PDSCH. The at least one setting could also be at least partly included in a Layer 1 DCI or MAC CE. The at least one setting could be included in a DCI used to allocate resources for a channel quality report message, e.g., an aperiodic or semi-periodic channel quality report message. The at least one setting can be included at least partly in a channel quality report message, as will be explained in further detail in connection with box 3020.

The at least one setting can be required to correctly interpret the information content of the channel quality report message. In other words, based on the at least one setting, it is possible to correctly interpret the CQI included in the channel quality report message. Accordingly, the at least one setting could also be referred to as assistance information for compiling the channel quality report message and for reading the channel quality report message.

The at least one setting can also include an indicator that is indicative of the UE setting the target error rate for which the CQI indicates the MCS. For instance, this indicator can be communicated from the communications NW to the UE, thereby granting the UE the right to select the target error rate autonomously; this is different to reference implementations where the communications NW sets the target error rate. In other examples, the target error rate could be set at the communications NW and then be indicated to the UE, either explicitly or implicitly.

Then, at box 3015, the UE can monitor for reference signals. This can be in accordance with conventional operation in the framework of a dynamic link adaptation protocol. For instance, the UE can monitor for downlink reference signals such as Channel State Information (CSI) reference signals. Respective techniques have been explained above in connection with FIG. 2: 9005.

Next, at box 3020, the UE provides, to the communications NW, the channel quality report message. The UE compiles the channel quality report message in accordance with the at least one setting that has been communicated at box 3010. This can, in particular, include determining the CQI included in the channel quality report message based on the at least one setting.

Accordingly, since the UE and the communications NW have exchanged information regarding the at least one setting at box 3010, additional information content can be conveyed in the channel quality report message that is based on the at least one setting.

In the scenario of FIG. 7, box 3010 and box 3020 are illustrated separately. I.e., the at least one setting is communicated separately from the channel quality report message. This is only one example. As a general rule, box 3010 and box 3020 can be integrated, i.e., the at least one setting can be included in the channel quality report message or be transmitted along with the channel quality report message.

According to various examples, multiple options are available for implementing the at least one setting. Some options will be explained next.

For instance, it would be possible that the at least one setting includes a parameter value of a parametrized ruleset for determining the CQI. This means that the parameterized ruleset can outline how to choose the value of the CQI, based on certain parameters. I.e., the parameter value can specify concretely instantiate the ruleset.

The at least one setting can be indicative of the parameter value.

As a general rule, it would be possible that the parameter value set by the UE and then communicated from the UE to the node. Alternatively or additionally, it would also be possible that the parameter value is set by the communications NW and communicated to the UE.

For instance, where the communications NW provides the parameter value, it can provide the parameter value prior to the UE providing the channel quality report message at box 3020. The UE requires the parameter value for determining the CQI at box 3020. On the other hand, where the UE determines the parameter value, it can include the parameter value in a channel quality report message provided at box 3020 so that the communications NW, specifically the BS, can correctly interpret the CQI.

The parametrized ruleset—i.e., the framework within which the parameter and the associated parameter value are defined—may be fixed, e.g., according to a communication protocol. Alternatively or additionally, it would also be possible that the at least one setting that is communicated between the node and the UE is indicative of the parametrized ruleset. Thereby, it would be possible to dynamically switch between multiple parametrized rulesets. Specifically, it would be possible that an indicator indicative of the parametrized ruleset is communicated from the node to the UE, or vice versa.

The largest degree of flexibility is obtained when being able to dynamically switch between multiple parameterized rulesets. On the other hand, a lean and efficient implementation is possible where the parametrized ruleset is fixed in the parameter values adjusted within the parametrized ruleset.

At box 3025, data of a data service is communicated. The data is encoded using an MCS that has been set based on a CQI included in the channel quality report message of box 3020.

Next, various options for implementing the at least one setting communicated at box 3010 will be explained in connection with the following FIGs.

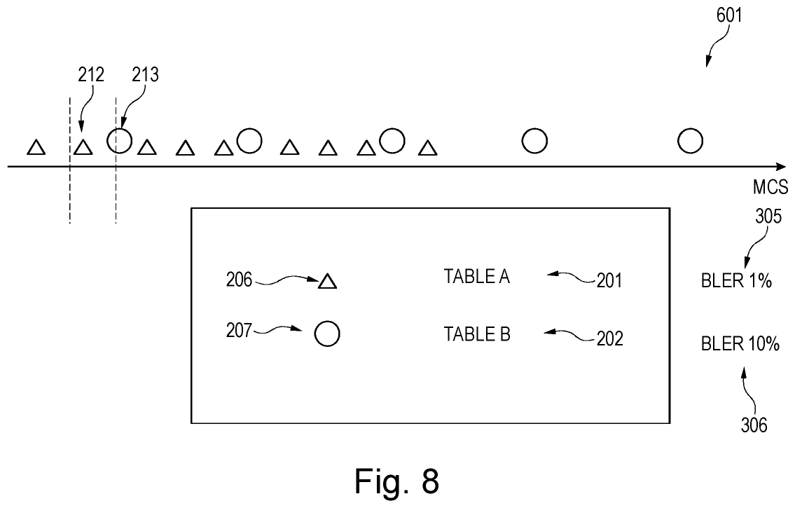

FIG. 8 schematically illustrates aspects with respect to determining the CQI in accordance with at least one setting. FIG. 8 schematically illustrates the determining of the CQI in accordance with a parameterized ruleset 601 that relies on multiple candidate mapping tables 201, 202. While hereinafter some scenarios will be explained in connection with two mapping tables 201, 202, it would be generally possible to rely on more than two mapping tables.

FIG. 8 schematically illustrates that at least one setting communicated between a node—such as the BS 112—and another node—e.g., the UE 101—includes a pointer to a mapping table, wherein the mapping table to which the CQI is referencing is selected by the UE.

As a general rule, according to the disclosed embodiments, a mapping table can be predefined in the standard defining the communication protocol. The mapping table can thus be locally stored in a memory of the respective device or node. The mapping table can be loaded from the memory.

An example mapping table is illustrated in TAB. 3 below. The mapping table maps values of the CQI (first column) to MCS values (second and third column).

TABLE 3
Example mapping table reproduced from 3GPP TS 38.214 V16.4.0
(2020-06): Table 7.2.3-1. The mapping table maps the CQIs
(CQI index) to MCSs (modulation and code rate).

| CQI index | modulation | code rate × 1024 | efficiency |
|---|---|---|---|
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

As illustrated in FIG. 8, it is possible to provide a pointer to a respective mapping table. In the illustrated example, two mapping tables 201, 202 are available and the pointer can be indicated for of either the mapping table “TABLE A” 201 or the mapping table “TABLE B” 202.

The different mapping tables 201-202 can be associated with different target error rates 305, 306, respectively.

In FIG. 8, the entries 206 of the mapping table “TABLE A” 201 are illustrated with triangles; and the entries of the mapping table “TABLE B” 202 are labeled with circles.

As illustrated in FIG. 8, the UE 101 may select a certain MCS based on one or more receive properties of the RSs, i.e., based on CSI measurements. Two selected MCSs 212, 213 are illustrated using dashed lines.

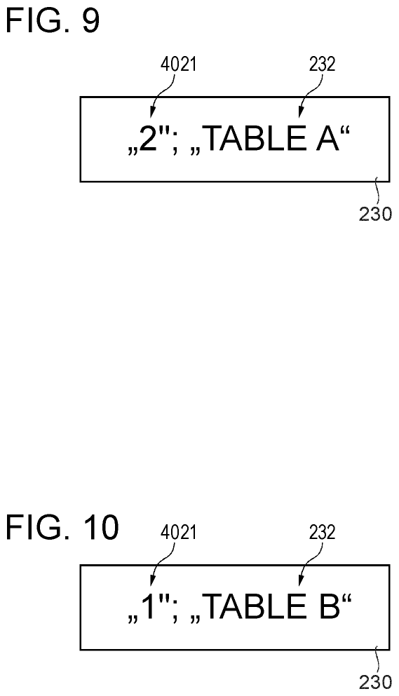

The UE 101 can then select between the available mapping tables 201, 202, depending on which mapping table 201, 202 has the closest entry 206, 207. For instance, if the UE 101 intends to suggest the MCS 212, it would select the second entry 206 of the mapping table “TABLE A” 201 (cf. FIG. 9: here, the CQI is “2” and the pointer 232 points to the mapping table “TABLE A” 2021); conversely, if the UE intends to suggest the MCS 213, it would include a pointer 232 to the mapping table “TABLE B” 202 and indicate the first entry 207 of that mapping table (cf. FIG. 10).

As will be appreciated from FIG. 8, FIG. 9, and FIG. 10, it is possible that the target error rate based on which the UE 101 determines the intended MCS 212, 213 differs from the target error rates 305, 306 associated with the mapping tables 201, 202. As such, the target error rates 305, 306 could be referred to as auxiliary target error rates 305, 306.

Thereby, an arbitrary target error rate—e.g., a target BLER between 10% and 0.001%—can be configured by the BS and indicated to the UE. The UE can then provide the channel quality report message—and specifically the CQI 4021—based on this (arbitrarily) configured target error rate. In other examples, the UE could select the target error rate. This could be enabled by the BS, by providing an indicator indicative of the UE setting the target error rate.

While according to legacy implementations, a specific mapping table would be defined for each target error rate and the UE is statically configured to use one of these mapping tables to report the CQI, according to the techniques described above, it is possible that the UE uses two or more existing mapping tables to provide the CQI for the configured target error rate. Here, the UE can indicate the CQI 4021 and the separate pointer 232 to the respective mapping table that the particular CQI 4021 belongs to. Thereby, it is not required to define multiple new mapping tables for multiple target error rates. The BS can configure a range of target error rates to care for specific applications providing data of a data service that have target error rates that are different to those defined in legacy systems, i.e., 10% and 0.001%.

For example, in an example mapping table A has values {1, 3, 5, 7, 9} and mapping table B has values {2, 4, 6, 8, 10}. Instead of a dedicated table with {1, 2, . . . , 10}, the UE can use both tables at the same time and provide a pointer to which particular mapping table the CQI references. So for example in reference techniques, if the UE indicates an CQI=“2”, in mapping table A, that means “3” and in mapping table B that means “4”; but according to the disclosed examples the UE can provide the CQI=2 from mapping table B and so giving a finer granularity. Finer granularity enables the BS to select the right MCS with suitable reliability (i.e., target BLER) in a resource efficient manner. For instance, the BS could—according to reference implementations—over-allocate the resources, i.e., always use the lowest MCS to ensure reliability; but such inefficient use of resource would lead to high energy consumption and low system level throughput, i.e. the BS could serve less UEs per time in the cell.

Thus, summarizing, instead of having one mapping table at a time, the UE can use—in a respective parameterized ruleset—two or more mapping tables contemporaneously to provide the channel quality report message, thereby offering a finer granularity in the indication of the MCS. At least one setting can include a parameter value of the parameterized ruleset that points to the respective mapping table.

The above—i.e., using a pointer to a certain mapping table—is only one example of a parametrized ruleset. In another example, the parameterized ruleset pertains to a UE-based calculation of the CQI based on multiple existing mapping tables and a respective combination of temporary CQIs associated with the multiple predefined mapping tables. The parameter value can pertain to a weighting parameter for the combination. For instance, if the target BLER is 1% then the UE will put more weight to the obtained temporary CQI based on a mapping table associated with BLER 10%, rather than the obtained temporary CQI which is based on a mapping table associated with BLER 0.001%. The at least one setting can be indicative of the parametrized ruleset to be applied, i.e., can be indicative of the channel quality report message being obtained from a weighted combination. The weighting parameters—as a parameter value of a parameterized ruleset indicated by the at least one setting—can be communicated in an upper-layer control message such as an RRC control message. It could also be included in a DCI or MAC CE for aperiodic channel quality reporting.

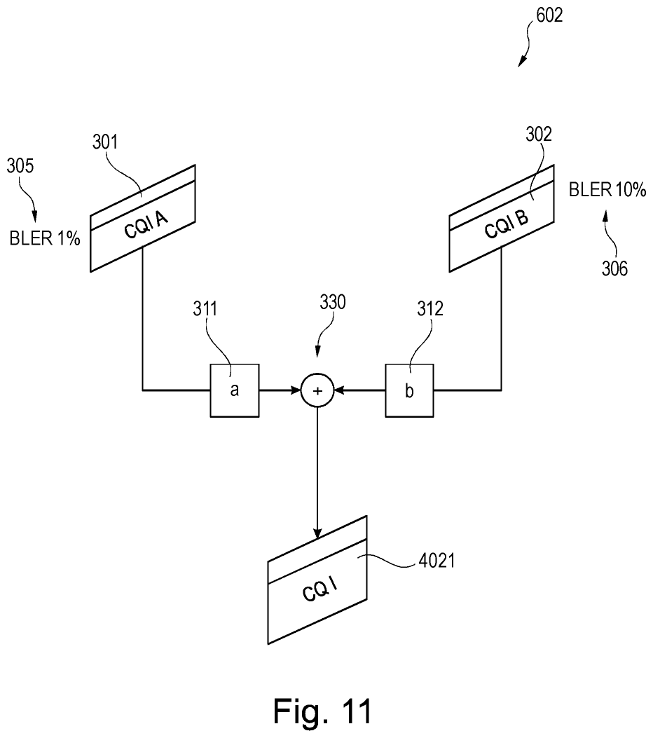

Details with such techniques of using a weighted combination of multiple temporary CQIs are illustrated in connection with FIG. 11.

FIG. 11 schematically illustrates aspects with respect to determining a CQI in accordance with at least one setting. FIG. 11 schematically illustrates the determining in accordance with a parameterized ruleset 602 that relies on a weighted combination 330 of multiple temporary CQIs 301, 302. While only two temporary CQIs 301, 302 are illustrated, as a general rule, more than two temporary CQIs 301, 302 may be used.

FIG. 11 schematically illustrates a scenario according to which of the at least one setting includes values of weighting parameter 311, 312 of a weighted combination of 330 of multiple temporary CQIs 301, 302 that are determined for multiple auxiliary target error rates 305, 306 of communicating of the data of the data service. Thereby, a final CQI 4021 is obtained. This is the CQI 4021 included in the channel quality report message 4020 (cf. FIG. 2). The temporary CQIs 301, 302 can be discarded.

As explained above, the weighting parameters can be set based on a difference between the multiple auxiliary target error rates and an actual target error rate. for instance, if the actual target error rate is closer to the auxiliary target error rate 305, then the value of the weighting parameter 311 can be larger than the value of the weighting parameter 312.

Thereby, an arbitrary target error rate—e.g., a target BLER between 10% and 0.001%—can be configured by the BS and indicated to the UE. The UE can then provide the channel quality report message—and specifically the CQI 4021—based on this (arbitrarily) configured target error rate. In other examples, the UE could select the target error rate. This could be enabled by the BS, by providing an indicator indicative of the UE setting the target error rate.

As a general rule, it would be possible that the values of the weighting parameter 311, 312 are set by the UE 101 (e.g., because the UE 101 selects the target error rate). Then, the UE 101 can indicate, to the BS 112, the values of the weighting parameter 311, 312. Instead of explicitly communicating the various of the weighting parameters 311, 312, it would also be possible that the UE communicates the intended target error rate. In other examples, it would be possible that the values of the weighting parameters 311, 312 or the target error rate are set by the BS 112 and then provided to the UE 101. if the target error rate is communicated, based on the respective parametrized ruleset, it may be possible to derive the values of the weighting parameters, even when not explicitly signaling the values of the weighting parameters.

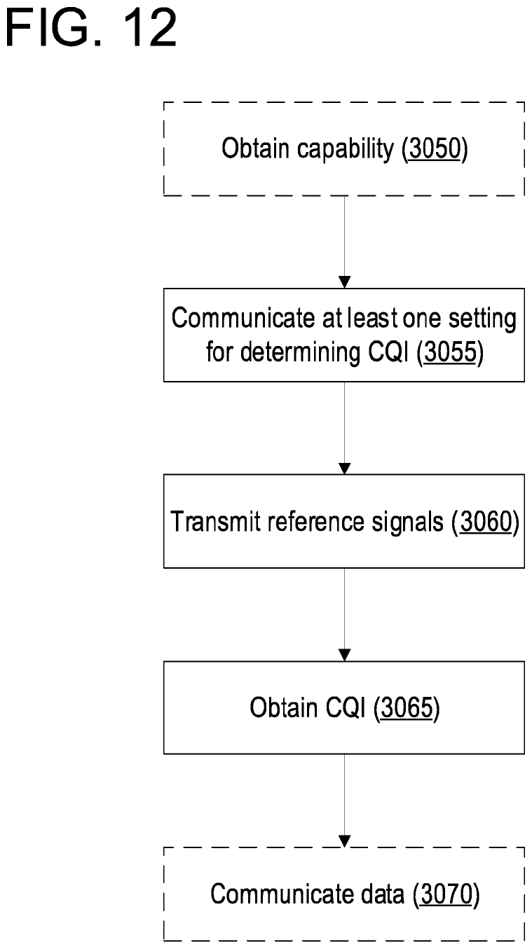

FIG. 12 is a flowchart of a method according to various examples. FIG. 12 illustrates aspects with respect to enhanced channel quality reporting according to TAB. 2: option I. The method of FIG. 12 can be executed by a node of a communications NW, e.g., by a BS. The BS can communicate with the UE. The BS can, in particular, communicate data of a data service associated with an application with the UE. For instance, the method of FIG. 12 may be executed by the BS 112. More specifically, it would be possible that the method of FIG. 12 is executed by the processor 1121 upon loading and executing program code from the memory 1122. The method of FIG. 12 is generally interrelated to the method of FIG. 7. Optional boxes are labeled with dashed lines.

At box 3050, the BS obtains a capability from the UE. The capability may be indicative of the UE being capable to engage in an enhanced dynamic link adaptation protocol. For example, the capability could be indicative of the UE being able to provide an enhanced channel quality report message, cf. TAB. 2: example I. Box 3050 is interrelated to box 3005.

Next, at box 3055, the BS transmits and/or receives at least one setting for determining the CQI—if supported by the capability of the UE. Respective details have been explained above in connection with box 3010. Further, examples of such at least one setting have been discussed in connection with FIG. 8, FIG. 9, FIG. 10, as well as FIG. 11.

At box 3060, the BS transmits reference signals. Box 3060 is, accordingly, interrelated to box 3015. The BS can transmit CSI-RSs.

At box 3065, the BS obtains a channel quality report message that has been compiled in accordance with the at least one setting communicated at box 3055. The channel quality report message includes a respective CQI. The CQI could be accompanied by a pointer to a mapping table, as explained above in connection with FIG. 8.

The CQI could also be determined based on a weighted combination of multiple temporary CQI, as explained above in connection with FIG. 11. The particular choice of the compilation of the channel quality report message is in accordance with the at least one setting of box 3055.

Then, at box 3070, it is possible to communicate data of the data service, based on an MCS that is selected based on the CQI included in the channel quality report message obtained at box 3065. Box 3070 is, accordingly, interrelated to box 3025.

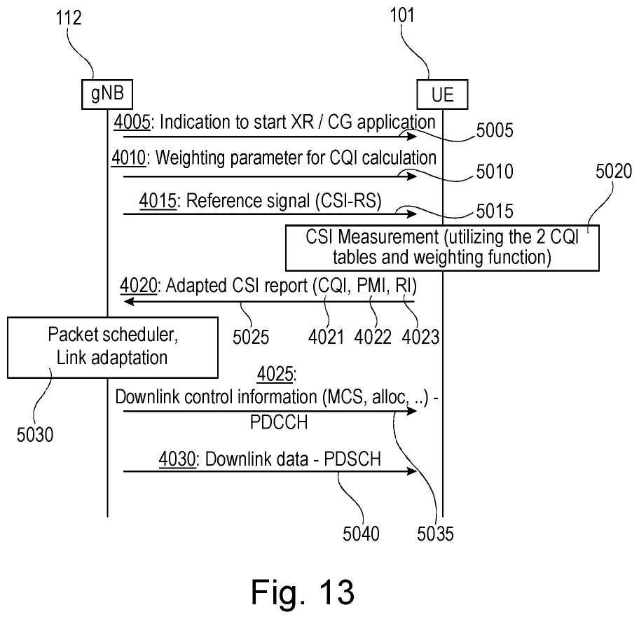

FIG. 13 is a signaling diagram of communication between the BS 112 and the UE 101. The signaling of FIG. 13 may implement the method of FIG. 7, as well as the method of FIG. 12. FIG. 13 illustrates aspects with respect to an enhanced dynamic link adaptation protocol. Specifically, FIG. 13 illustrates aspects with respect to an adapted channel quality report message, cf. TAB. 2, example I.

At 5005, the BS transmits an indication to start a communication of data of a data service that is associated with a certain application. For instance, at 5005, it would be possible to set up a data connection 189 that includes a dedicated bearer to convey such data.

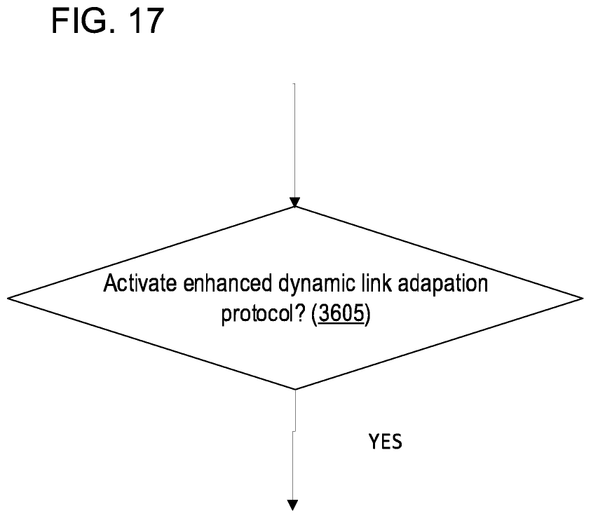

This could be a trigger event for using enhanced channel quality reporting, e.g., according to TAB. 2: option I. Examples with such and further trigger events will be explained later in connection with the flowchart of FIG. 17.

At 5010, the BS 112 provides a weighting value of a weighting parameter for the determining of a CQI 4021 to be included in a channel quality report message 4022 transmitted by the UE 101. For instance, the values of the weighting parameters 311, 312, as discussed above in connection with FIG. 11, could be provided to the UE 101.

Accordingly, 5010 implements box 3010 and box 3055 of the methods of FIG. 7 and FIG. 12, respectively.

At 5015, the BS transmits RSs 4015. Respective aspects have already been explained above in connection with FIG. 2: 9005.

Accordingly, 5015 implements box 3015 of the method of FIG. 7, as well as box 3060 of the method of FIG. 12.

Then, at 5020, the UE 101 implements a measurement on the RSs 4015. In particular, the UE 101 determines two CQIs (in other examples, the UE 101 can determine more than two CQIs).This is based on the values of the weighting parameters as provided at 5010. For instance, the weighted combination 330 as discussed above in connection with FIG. 11 can be executed at box 5020.

Next, at 5025, the UE 101 provides and adapted channel quality report message 4020. Specifically, the adapted channel quality report message 4020 includes the CQI 4021 that has been determined based on two temporary CQIs 301, 302 using the weighted combination 330, at 5020.

Accordingly, 5025 implements box 3020 of the method of FIG. 7, as well as box 3065 of the method of FIG. 12.

Then, the BS, in a conventional manner can execute link adaptation at 5030 (in order to correctly interpret the CQI 4021, the BS 112 is aware of the UE 101 having used the weighted combination), provide DCI 4025 at 5305, and transmit downlink application data 4030 at 5040.

Accordingly, 5030, 5035, and 5040 implement box 3025 of the method of FIG. 7, as well as box 3070 of the method of FIG. 12, respectively.

Above, various examples of an enhanced dynamic link adaptation protocol using an adapted channel quality report message, according to TAB. 2: example I, have been explained. Next, various scenarios will be described with respect to the rich channel quality reporting, according to the TAB. 2: example II.

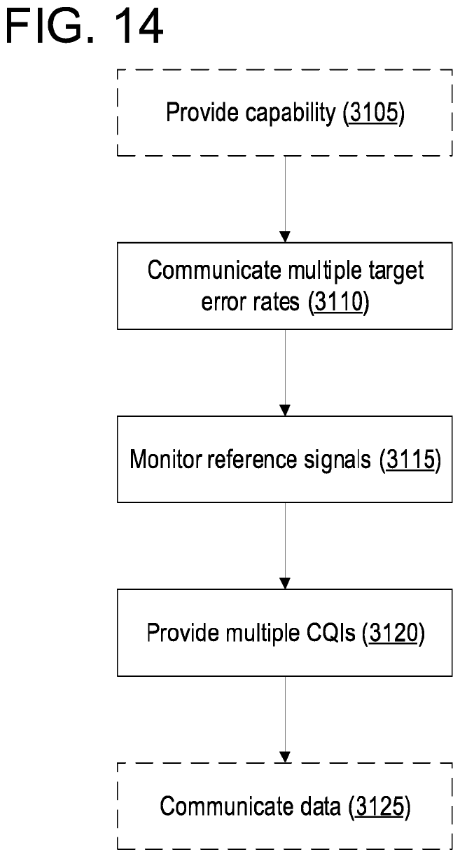

FIG. 14 is a flowchart of a method according to various examples. FIG. 14 illustrates aspects with respect to enhanced channel quality reporting according to TAB. 2: example II. For instance, the method of FIG. 14 can be executed by a UE. The UE can communicate with a communications network. The UE could communicate with a BS of the communications network. The UE could be the UE 101. In further detail, the method of FIG. 14 could be executed by the processor 1011 upon loading program code from the memory 1012. Optional boxes are labeled using dashed lines in FIG. 14.

At box 3105, the UE can indicate, to the communications NW, its capability to participate in an enhanced dynamic link adaptation protocol. Specifically, the UE can indicate its capability to the provide rich channel quality reporting according to TAB. 2: example II. I.e., multiple CQIs can be provided for multiple target error rates.

The UE could transmit, to the communications network, a control message, e.g., a higher-layer control message, e.g., a Layer 3 control message such as a RRC control message communicated on the PUSCH. The control message can be indicative of its capability, as explained above.

At optional box 3110, multiple target error rates are indicated by the UE to the communications NW, or vice versa. The multiple target error rates serve as references for subsequent channel quality reporting. For instance, the UE could set the multiple target error rates and provide a respective indication to the communications NW. It would also be possible that the communications NW—e.g., a BS—sets the multiple target error rates and provides a respective indication to the UE.

Such indication can at least partly be included in a higher-layer control message, e.g., a Layer 2 or Layer 3 control message. For instance, an RRC control message may be communicated on PUSCH or PDSCH. The respective indication could also be at least partly included in a Layer 1 DCI or MAC CE. The at least one setting could be included in a DCI used to allocate resources for a channel quality report message, e.g., an aperiodic or semi-periodic channel quality report message. The indicator could also be at least partly included in the channel quality report message.

In other examples, the multiple target error rates could be fixedly predefined, e.g., in accordance with a communication protocol.

At box 3115, the UE can monitor for RSs. This can be in accordance with conventional operation in the framework of a dynamic link adaptation protocol. For instance, the UE can monitor for downlink RSs such as CSI RSs. The UE can determine a receive amplitude and/or phase. Respective techniques have been explained above in connection with FIG. 2: 9005. Box 3115 corresponds to box 3015 of FIG. 7.

At box 3120, the UE provides multiple CQIs to the communications NW. Each CQI is indicative of a respective MCS for said communicating of data of the data service in accordance with a respective one of the multiple target error rates.

For instance, the multiple CQIs can be included in multiple channel quality report messages. The multiple channel quality report messages may be provided at different reporting rates to the communications NW.

Alternatively, it would be possible that the multiple CQIs are aggregated in a shared channel quality report message. This shared channel quality report message could then include a single precoding matrix indicator and/or a single rank index.

As will be appreciated from the above, the UE can provide multiple CQIs and then the BS can decide on the selected MCS based on the multiple CQIs. It would be possible that multiple channel quality report messages are scheduled. Thus, if a count N CQIs is reported, then, a respective multiple N of the time-frequency resources required for a single channel quality report message including a single CQI can be allocated. On the other hand, it is possible that the PM and RI are not duplicated and then less than the proportionate amount of resources required. Based on the multiple CQIs, the BS can estimate—e.g., interpolate—the suitable MCS for the desired target error rate, that could be arbitrarily set at the BS.

At box 3225, the data of the data service associate with a certain application can be communicated, using the suitable MCS.

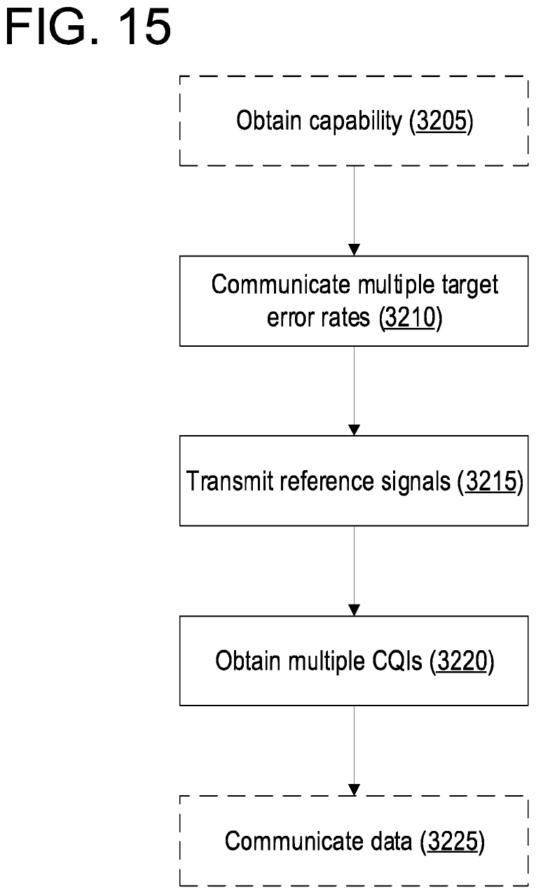

FIG. 15 is a flowchart of a method according to various examples. FIG. 15 illustrates aspects with respect to enhanced channel quality reporting according to TAB. 2: example II. For instance, the method of FIG. 15 can be executed by a node of a communications NW such as a BS. The BS can communicate with a UE. The BS could be the BS 112. In further detail, the method of FIG. 15 could be executed by the processor 1121 upon loading program code from the memory 1122. Optional boxes are labeled using dashed lines in FIG. 15. The method of FIG. 15 is generally inter-related to the method of FIG. 14.

At box 3205, the BS obtains, from the UE, the capability of the UE to participate in an enhanced dynamic link adaptation protocol. Specifically, the UE could indicate its capability to provide rich channel quality reporting according to TAB. 2: example II. I.e., multiple CQIs can be provided for multiple target error rates. Respective aspects have been discussed in connection with box 3105 above, to which box 3205 is inter-related.

Optionally, at box 3210, the BS transmits configuration related to multiple target error rates to the UE, or vice versa. Respective techniques have been discussed above in connection with box 3110, to which box 3210 is interrelated.

The BS transmits RSs to the UE at box 3215.

At box 3220, the BS obtains multiple CQIs from the UE. Accordingly, box 3220 is interrelated to box 3120.

The multiple CQIs are indicating MCSs for different target error rates, e.g., the target error rates that have been communicated at box 3210, or multiple predefined target error rates.

Then, based on the CQIs obtained at box 3220, the BS can appropriately set the MCS for communicating data at box 3225. The data can belong to a data service that is associated with a certain application.

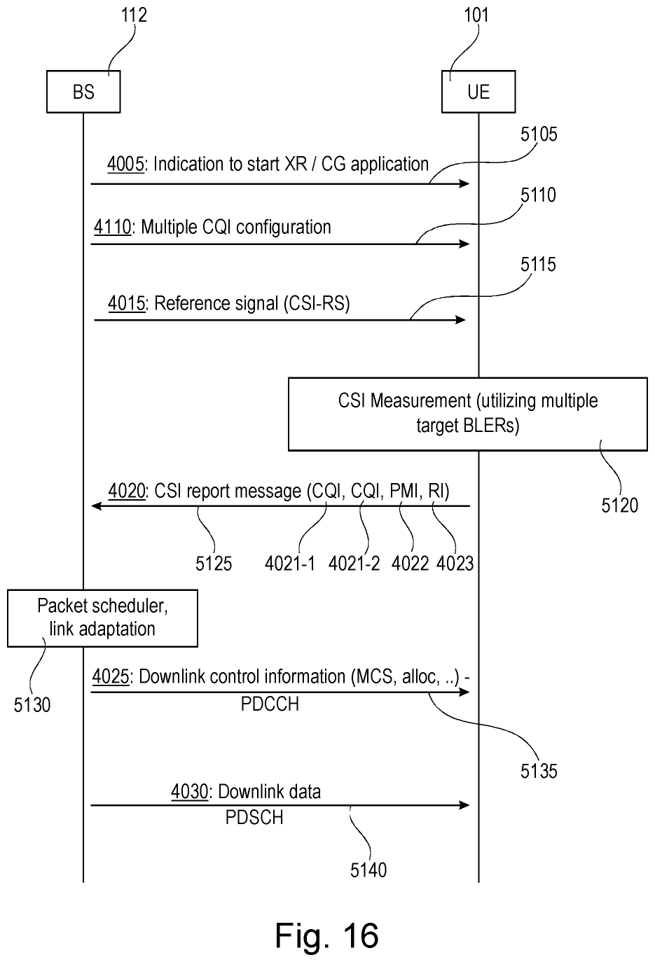

FIG. 16 is a signaling diagram of communication between the BS 112 and the UE 101. The signaling of FIG. 16 can implement the method of FIG. 14, as well as the method of FIG. 15. FIG. 16 illustrates aspects with respect to an enhanced dynamic link adaptation protocol. Specifically, FIG. 16 illustrates aspects with respect to rich channel quality reporting, cf. TAB. 2: example II.

At 5105, the BS 112 transmits an indication to start a communication of data of a data service that is associated with a certain application. For instance, at 5105, it would be possible to set up a data connection 189 that includes a dedicated bearer to convey such data.

The start of the communication can serve as a trigger event for rich channel quality reporting. Aspects with respect to such conditional execution of an enhanced dynamic link adaptation protocol will be discussed below in connection with FIG. 17.

At 5110, the BS 112 provides a control message 4110 to the UE 101 that is indicative of the request to provide multiple CQIs. For instance, the control message 4110 could be conditionally provided, in case the capability of the UE supports such multi-CQI reporting (aspects with respect to communicating the capability of the UE have been discussed above in connection with box 3105 and box 3205).

The control message 4110 could also be indicative of the multiple target error rates for which the multiple CQIs are to be determined. Thus, 5110 can correspond to box 3110 and box 3210.

At 5115, the BS 112 transmits RSs 4015. Respective aspects have already been discussed above in connection with, e.g., FIG. 13: 5015.

Then, the UE 101, at 5120, implements a measurement on the RSs 4015. In particular, the UE 101 determines multiple CQIs, i.e., a CQI for each one of multiple target error rates. It would be possible that the multiple target error rates are indicated by the control message 4110. It would also be possible that the multiple target error rates are predefined, e.g., in accordance with a communication protocol.

Next, at 5125, the UE 101 provides a channel quality report message 4020 to the BS 112. The channel quality report message includes multiple CQIs 4021-1, 4021-2, as well as the PMI 4022 and the RI 4023. As such, the multiple CQIs 4021-1, 4022-2 are aggregated in a shared channel quality report message 4020. It would, in an alternative scenario, be possible that multiple channel quality report messages 4020 are communicated, each one of the multiple channel quality report messages 4020 including a single CQI associated with a respective target error rate. For instance, these multiple channel quality report messages 4020 could be provided at different reporting rates by the UE 101. These reporting rates could be specified in the control message 4110.

The BS, in a conventional manner can execute link adaptation at 5130. I.e., a respective MCS can be selected. Then, downlink application data 4030 that is eventually communicated at 5140 is scheduled using a DCI 4025 at 5135. In general, this can also be applied for uplink application data. The uplink application data 4030 is scheduled using a DCI 4025. This is particularly in the case of TDD where uplink and downlink are sharing the same frequency.

Above, various scenarios have been described according to which an enhanced dynamic link adaptation protocol is implemented. These techniques can be based on an enhanced channel quality report message—cf. TAB. 1: example I—and/or based on rich channel quality reporting—cf. TAB. 2: example II. According to various examples, it would be possible that such enhanced dynamic link adaptation protocol is selectively activated. For instance, an indication can be provided when such operation will be started or terminated. The indication could be from the UE to the BS, or vice versa. Respective aspects are illustrated in connection with FIG. 17.

FIG. 17 is a flowchart of a method according to various examples. The method of FIG. 17 could any one of the methods according to FIG. 7, FIG. 12, FIG. 14, or FIG. 15.

At box 3605, is checked whether the enhanced dynamic link adaptation protocol is to be activated. For instance, it could be checked whether one or more of the operational modes according to TAB. 2 are to be activated.

The check at box 3605 can be based on one or more trigger events. Example trigger events include: a control message received from the UE or from the BS; establishment of a data connection for conveying data of a data service associated with a certain application, e.g., an extended reality application, etc; activation of a data service associated with a certain application; a channel condition of a radio link between the BS 112 and the UE 101.

As a general rule, multiple such and further trigger events can be used cumulatively.

To give an example, an indication to activate the enhanced dynamic link adaptation protocol could be typically driven by the application running on the UE, while indication from the BS could be typically driven by the packet flow that arrives at the BS. In indication to activate the dynamic link adaptation protocol could be included in a higher-layer control message such as a Layer 3 control message, e.g., an RRC control message.

For instance, the UE or the BS may receive application data pertaining to a certain application—e.g., an XR application—from a higher layer. Respective application data may thus be buffered for transmission. The higher-layer signaling can be in the form of an explicit indication of XR application data or explicit signaling in another form, e.g., service level requirements. Considering that the application requires higher data rates with certain reliability. Then, the BS 112 and/or the UE 101 activate the enhanced dynamic link adaptation protocol. The enhanced dynamic link adaptation protocol requires more signaling to deliver high reliability for high data rates. Therefore, it is possible to only activate the dynamic link adaptation protocol on-demand, as illustrated in connection with FIG. 17.

The conditional activation could also depend on the channel quality of the radio link between the UE and the BS. For instance, the activation can require a minimum RS received power. In general, the transmission with certain service level requirements—e.g., as would be the case for an XR/CG application—may only be supported when the UE experiences appropriate radio channel conditions. Hence, it can deliver high data rate transmission and aiming at no/small retransmissions (i.e., small packet delay). If the UE is at the cell edge, not having a good radio channel condition, the enhanced dynamic link adaptation protocol may not be activated.

Although the invention has been shown and described with respect to certain preferred embodiments, equivalents and modifications will occur to others skilled in the art upon the reading and understanding of the specification. The present invention includes all such equivalents and modifications and is limited only by the scope of the appended claims.

For illustration, above, various scenarios have been discussed with respect to communication of downlink data. As a general rule, similar techniques may be readily applied for uplink data or sidelink data.

1. A method of operating a wireless communication device communicating data with a node of a communications network, the method comprising:
communicating, between the node and the wireless communication device, at least one setting to be used at the wireless communication device for determining a channel quality indicator, the channel quality indicator being indicative of at least one modulation and/or coding value for said communicating of the data in accordance with a target error rate of said communicating of the data,
monitoring of reference signals transmitted by the node, and
based on said monitoring of the reference signals: providing, to the node, the channel quality indicator determined in accordance with the communicated at least one setting.

2. The method of claim 1,
wherein the at least one setting comprises a pointer to a mapping table selected by the wireless communication device from a plurality of candidate mapping tables based on the target error rate, each candidate mapping table mapping values of the channel quality indicator to a respective modulation and/or coding value, different ones of the plurality of candidate mapping tables being associated with different ones of multiple auxiliary target error rates,
wherein the pointer is communicated from the wireless communication device to the node.

3. The method of claim 1, wherein the at least one setting comprises values of weighting parameters of a weighted combination of multiple temporary channel quality indicators determined for multiple auxiliary target error rates of said communicating of the data, to thereby obtain the channel quality indicator.

4. The method of claim 3,
wherein the values of the weighting parameters are set by the communications network and communicated from the node to the wireless communication device, and/or
wherein the target error rate is set by the communications network and communicated from the node to the wireless communication device.

5. The method of claim 3,
wherein the values of the weighting parameters are set by the wireless communication device and communicated from the wireless communication device to the node, and/or
wherein the target error rate is set by the wireless communication device and communicated from the wireless communication device to the node.

6. The method of claim 3, wherein the values of the weighting parameters are set based on a difference between the multiple auxiliary target error rates and the target error rate.

7. The method of claim 1, wherein the at least one setting comprises an indicator indicative of the wireless communication device setting the target error rate of said communicating of the data.

8. The method of claim 7, wherein the indicator indicative of the wireless communication device setting the target error rate is communicated from the node to the wireless communication device.

9. The method of claim 1,
wherein the at least one setting comprises a parameter value of a parameter of a parameterized ruleset for determining the channel quality indicator at the wireless communication device,
wherein the parameter value is set by the wireless communication device based on the target error rate,
wherein the parameter value is communicated from the wireless communication device to the node.

10. The method of claim 9,
wherein the at least one setting comprises an indicator indicative of the parameterized ruleset
wherein the indicator indicative of the parameterized ruleset is communicated from the node to the wireless communication device.

11. The method of claim 1, wherein the at least one setting is at least partly included in a channel quality report message that further comprises the channel quality indicator.

12. A method of operating a wireless communication device communicating data with a node of a communications network, the method comprising:
monitoring of reference signals transmitted by the node, and
based on said monitoring of the reference signals: providing multiple channel quality indicators to the node, each channel quality indicator of the multiple channel quality indicators being indicative of a respective modulation and/or coding value for said communicating of the data in accordance with a respective one of multiple target error rates.

13. The method of claim 12, wherein the multiple channel quality indicators are included in multiple channel quality report messages that are provided at different reporting rates to the node.

14. The method of claim 13, wherein the multiple channel quality indicators are aggregated in a shared channel quality report message.

15. The method of claim 12, further comprising:
communicating, between the wireless communication device and the node, an indication of the multiple target error rates.

16. A wireless communication device for communicating data with a node of a communications network, the wireless communication device comprising a control circuitry, the control circuitry being configured to:
communicate, between the node and the wireless communication device, at least one setting to be used at the wireless communication device for determining a channel quality indicator, the channel quality indicator being indicative of at least one modulation and/or coding value for said communicating of the data in accordance with a target error rate of said communicating of the data,
monitor reference signals transmitted by the node, and
based on said monitoring of the reference signals: provide, to the node, the channel quality indicator determined in accordance with the communicated at least one setting.

17-23. (canceled)
